(19) United States
(12) Patent Application Publication
(10) Pub. No.: US 2007/0053674 A1
(43) Pub. Date: Mar. 8, 2007

(54) Soft-focus photographing device

(75) Inventor: Kazumi Koike, Minami-Ashigara-shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM CO., LTD., MINAMI-ASHIGARA-SHI (JP)

(21) Appl. No.: 11/511,418

(22) Filed: Aug. 29, 2006

(30) Foreign Application Priority Data
Sep. 6, 2005 (JP) 2005-258419

(51) Int. Cl. G03B 17/02; G03B 13/00; G02B 7/28

(52) U.S. Cl. 396/111; 396/6

(57) ABSTRACT

In a soft-focus photography mode, a zone plate section is inserted into a photographing optical path to be set between a front lens and a rear lens. The zone plate section is formed with a central transparent part that functions as a pinhole and a plurality of ring-shaped transparent parts for increasing light amount. Light passed thought the front lens, the zone plate section, and the rear lens falls on a photo film through a shutter that is set at slow speed. In a normal photography mode, the zone plate section retreats from the photographing optical path and the shutter is set at fast speed.

### FIELD OF THE INVENTION

The present invention relates to a soft-focus photographing device for photographing an image that has a soft blur around a sharp image.

### BACKGROUND OF THE INVENTION

In a soft-focus photography, for example, a soft-focus lens using lens aberration, a filter having light diffusion properties, or a zone plate using diffraction of light is employed.

In the soft-focus photography using lens aberration, spherical aberration is undercorrected or overcorrected to obtain soft-focus effect to diffuse an outline of a subject in an entire image. “Imagon” (trade name, manufactured by Rodenstock) and “Thambar” (trade name, manufactured by Leitz) are conventionally known as a lens for soft-focus photographing. “Imagon” comes with a plural types of stops each of which has a central circular opening and a plurality of circular openings around the central circular opening, and a soft-focus effect can be adjusted by changing the type of the stops. “Thambar” has a stop identical with those of a normal lens, but instead, the light passing near an optical axis of a lens is blocked and f-number is changed to allow for adjustment of soft-focus effect. JP-A 10-068879 discloses a soft-focus lens whose spherical aberration can be freely adjusted by changing an interval between two lenses to obtain the soft-focus effect regardless of stop values.

JP-A 07-209697 and JP-A 10-232461 disclose that a light diffusible filter made of a translucent member having a surface on which minute concavities and convexities are formed is inserted into a photographing optical path to obtain a desired soft-focus effect. The soft-focus effect can be determined according to the size and density of the concavities and convexities on the translucent member.

When a zone plate is used, an image is formed by diffraction of light passed through a tiny opening without using a lens as with a pinhole camera. Since an opening of the pinhole camera is small (a large f-number), an image becomes dark, and long exposure is required for obtaining enough light. The zone plate is provided with a central circular transparent part or a central circular opening, and a plurality of ring-shaped transparent parts around it in a concentric fashion to produce strong soft-focus effect by means of diffraction of light diffracted at the ring-shaped transparent parts. In the zone plate, the central circular transparent part functions as a pinhole of the pinhole camera, and each ring-shaped transparent part has substantially the same area as the central transparent part. Therefore, in the zone plate, exposure amount can be increased compared to the pinhole camera, by increasing the number of the ring-shaped transparent parts. For example, when the zone plate formed with the central circular transparent part and the 4 ring-shaped transparent parts is used, exposure amount equivalent to 2.3 EV can be obtained, and when the zone plate formed with the central circular transparent part and the 8 ring-shaped transparent parts is used, exposure amount equivalent to 3.2 EV can be obtained.

However, in the soft-focus photography using lens spherical aberration, a lens having a large spherical aberration is required. Such lens can not be used for normal photography, and consequently, a special soft-focus lens is required, resulting in increase of manufacturing cost of a camera. In addition, in order to obtain a certain amount of soft-focus effect, large spherical aberration is required for a slow lens whose f-number is large. So, in a camera using a pan focus lens whose f-number is large such as a known lens-fitted photo film, it is difficult to obtain both of the spherical aberration and resolution power. Similarly, in the light diffusible filter, whilst well soft-focus effect can be obtained when a fast lens whose f-number is small is used, resolution power cannot be obtained when a slow lens is used.

Since the zone plate offers image-forming performance in a similar manner to the pinhole camera, an increase of the area of the circular transparent part and the ring-shaped transparent parts is required for obtaining brightness of the image. However, there is a disadvantage that the soft-focus effect becomes excessively strong when the area of the transparent parts are increased and the entire image becomes blurry.

### SUMMARY OF THE INVENTION

An object of the present invention is to provide a soft-focus photographing device of a zone plate type capable of increasing exposure amount without increasing an area of transparent parts.

Another object of the present invention is to provide a soft-focus photographing device capable of selectively taking a normal photograph or a soft-focus photograph.

To achieve the above object and other objects, a soft-focus photographing device of the present invention includes a photographing lens disposed on a photographing optical path for forming a subject light image on an image forming plane, a shutter disposed on the photographing optical path for controlling light amount of the subject light, and a zone plate set on the photographing optical path. The zone plate includes a central circular transparent part (including an opening part) located on the center of the photographing optical path, and either a plurality of the ring-shaped transparent parts with different diameters around the central circular transparent part or a plurality of the circular transparent parts (including openings) disposed on each of the concentric circle with different diameters.

Each of the ring-shaped transparent parts or a total of the circular transparent parts disposed on each concentric circle has nearly the same area as the central circular transparent part. The zone plate is freely insertable and removable from the photographing optical path. The zone plate is set on the photographing optical path in the soft-focus photography mode or retreats from the photographing optical path in the normal photography mode.

The shutter is set at slow speed in the soft-focus photography mode. It is preferable that f-number of the photographing lens is greater than f/5.6. The photographing lens is composed of a first lens for correcting a curvature of field and a second lens for forming the image. The zone plate is disposed between the first and second lenses. The zone plate has a thickness of at most 0.5 mm. A photo film having ISO sensitivity of at least 800 is disposed in the image forming plane.

According to the present invention, the photographing lens is used with the zone plate to produce a soft photographing depiction where an outline of the subject is diffused through the combination of the resolution power of the photographing lens and diffracted light obtained by the zone plate. In addition, since sharpness of the image is ensured by using the lens with the zone plate, the central circular transparent part and a plurality of the ring-shaped transparent parts or a plurality of the circular transparent parts disposed on the concentric circles of the zone plate are not limited in size. Therefore, the size of each transparent part can be changed to provide a broad adjustable range of the soft-focus effect. Since the zone plate is insertable and removable from the photographing optical path, the normal photography using the photographing lens and the soft-focus photography using the photographing lens and the zone plate are selectable. Moreover, in the soft-focus photography, the low shutter speed is set to prevent insufficient light amount due to the zone plate.

Since the thickness of the zone plate is at most 0.5 mm, deviation in focus due to insertion and removal of the zone plate to and from the photographing optical path can be minimized. Since the zone plate is disposed between the first lens for correcting a curvature of field and the second lens for forming the image, deviation in focus can be further reduced. Particularly, the structure of the present invention is simple and inexpensive, so the present invention is suitable for a lens-fitted photo film unit with a built-in photographing lens of a fixed focal distance having a large f-number.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is an external perspective view of a lens-fitted photo film unit;

FIG. 2 is an exploded perspective view of the lens-fitted photo film unit;

FIG. 3 is an exploded perspective view showing a shutter blade and a periphery of a taking lens;

FIG. 4 is a plan view showing an active condition of the shutter blade in a normal photography mode;

FIG. 5 is a plan view showing the active condition of the shutter blade in a soft photography mode;

FIG. 6 is a plan view showing a position of a zone plate section in the normal photography mode;

FIG. 7 is a plan view showing the position of the zone plate section in the soft photography mode;

FIG. 8 is an enlarged view of the zone plate section, and

FIG. 9 is an enlarged view of the zone plate section in another embodiment.

### DESCRIPTION OF THE PREFERRED EMBODIMENTS

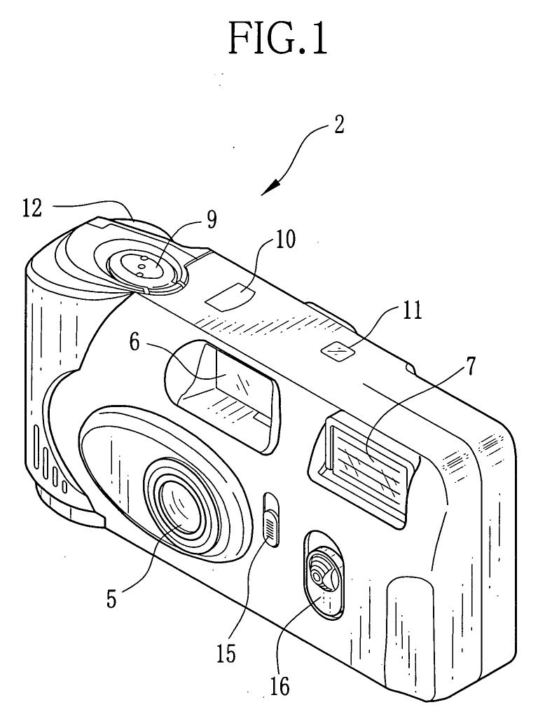

In FIG. 1, a lens-fitted photo film unit 2 has a front face provided with a taking lens 5 for forming a subject light image on an image forming plane, a viewfinder 6 for visibly confirming an image shooting field, a flash emitter 7 for emitting flashlight that illuminates a subject in a photography at night time. The lens-fitted photo film unit 2 has an upper face provided with a shutter button 9 that is depressed for shooting, a counter window 10 for counting the number of exposures, a signaling member 11 that illuminates when charging for the flashlight is completed.

The lens-fitted photo film unit 2 has a back face which partially exposes a film winding wheel 12 for winding one frame of a photo film. Provided on the front face of the lens-fitted photo film unit 2 are a mode changeover switch 15 for selecting either of a normal mode for taking a normal photograph or a soft mode for taking a soft-focus photograph, and a flash switch 16 that is slidable downward and upward for turning on and off. The mode changeover switch 15 is slid down for selecting the normal photography and slid up for the soft photography. When the flash switch 16 is slid up to an ON position, a flash circuit starts charging. When the charging of the flash circuit is completed, the signaling member 11 illuminates and flash light is emitted when the shutter button 9 is depressed for shooting.

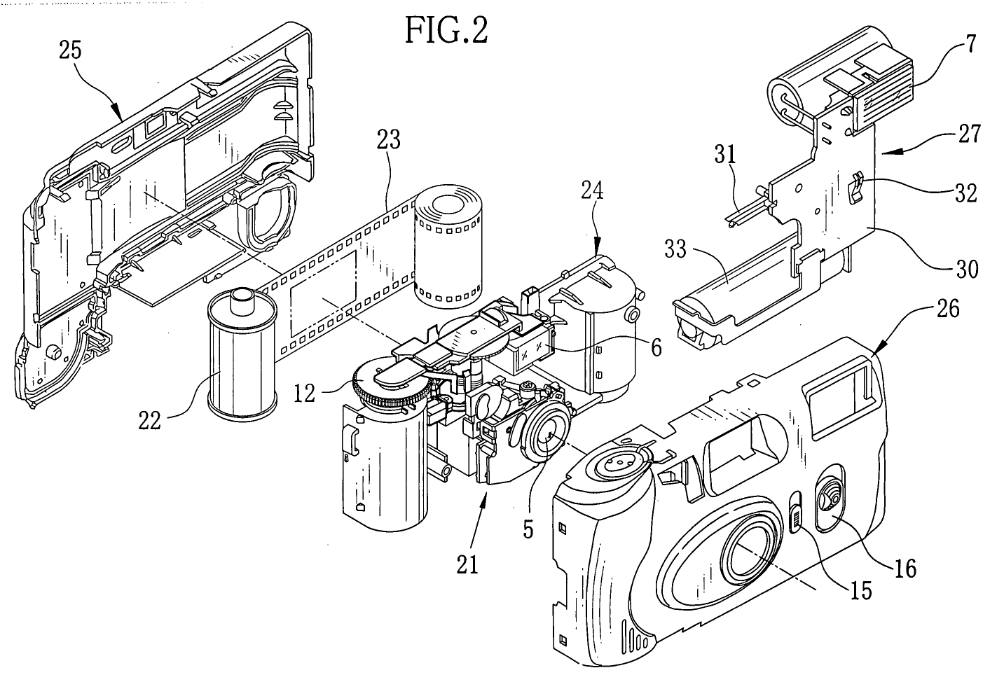

In FIG. 2, the lens-fitted photo film unit 2 includes a 135 type film cartridge 22, a body base 24 preloaded with a photo film 23 that is pull out of the cartridge 22, a rear cover 25 containing the photo film 23 in a light-tight fashion by covering a rear face of the body base 24, and a front cover 26 that is attached to a front side of the body base 24. A high sensitivity film at least ISO 800 is used for the photo film 23, so that appropriate exposure can be obtained at the shutter speed to prevent camera shake even when a slow lens with large f-number is used for the taking lens 5.

A flash unit 27 is assembled to an exposure unit 21. The flash unit 27 includes a printed circuit board 30 attached with plural circuit elements, the flash emitter 7 provided with such as a flash emitting tube and reflector, a syncro switch 31 that is turned on by actuation of the shutter blade, a charging switch 32 that is turned on by operation of the flash switch 16 and a battery 33.

The exposure unit 21 includes a shutter, a film winding stop mechanism, a film count mechanism, and a shutter speed changeover mechanism. When the film winding wheel 12 is rotated in a film winding direction, a sprocket (not shown) is rotated according to winding amount of the photo film 23. The rotation of the sprocket is transmitted to the shutter, the film winding stop mechanism, and the film count mechanism. When the winding amount of the photo film reaches the length of one frame, the shutter is charged. The rotation of the film winding wheel 12 is locked by the film winding stop mechanism and the number of the photographing frames advances one frame by the film counting mechanism.

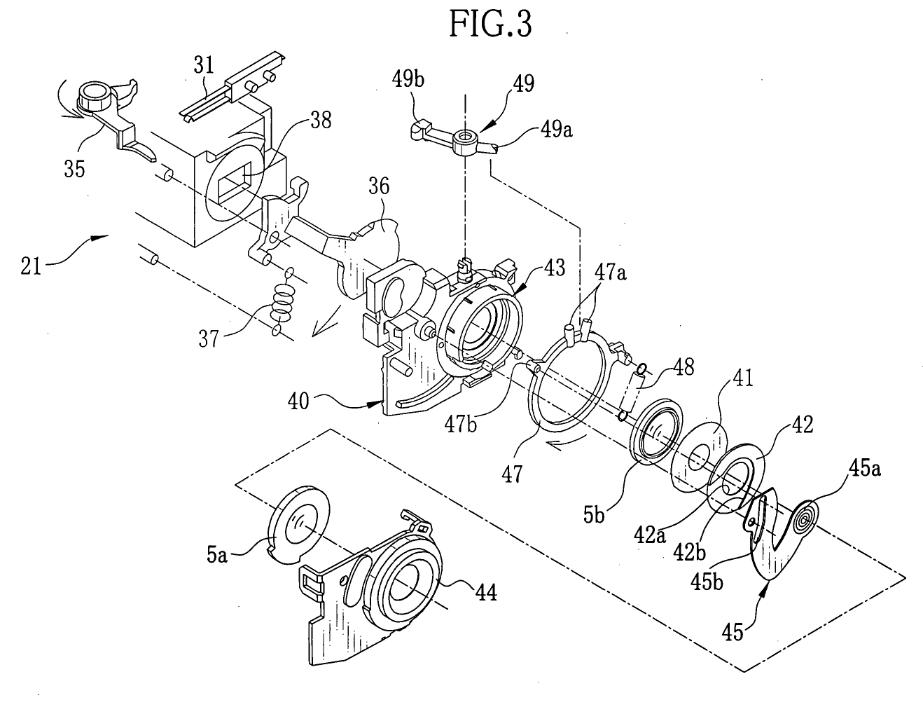

In FIG. 3, the shutter is composed of a shutter drive lever 35, a shutter blade 36, a shutter aperture 38 and a spring 37. The shutter drive lever 35 is rotated for film winding in an opposite direction to an arrow shown in the figure and is locked in a shutter charging state. When the shutter button 9 is depressed, the shutter drive lever 35 is released and rotated in an arrow direction toward a release position from a charging position by bias of a spring (not shown). The shutter blade 36 is biased by the spring 37 to a close position to close the shutter aperture 38. The shutter drive lever 35 kicks the shutter blade 36 to open the shutter aperture 38. When the shutter drive lever 35 is returned to an uncharged position, the lock by the film winding stop mechanism is released and film winding for the following frame can be performed.

A shutter cover 40 is provided in front of the shutter blade 36. The shutter cover 40 is provided with a lens attaching frame 43 to which the taking lens 5, a flare preventing frame 41 and a spacer plate 42 are attached. The taking lens 5 is composed of a front lens 5a formed in a convex meniscus shape and a rear lens 5b formed in a biconvex shape. The front lens 5a corrects a curvature of field and the rear lens 5b forms an image. The taking lens 5 is pressed from its front side by a lens retention plate 44 that is attached to a front face of the shutter cover 40 and is supported inside the lens attaching frame 43. A lens whose f-number is greater than f/8 is used for the taking lens 5. Thereby, the lens-fitted photo film unit 2 has pan focus that eliminates the need for focusing when a photograph is taken, then the photograph is easily taken only by depressing the shutter button 9 after visibly confirming the image shooting field through the view finder 6.

The spacer plate 42 has an opening 42a and a concave 42b for insertion and removal of a “V”-shaped photography mode changeover plate 45. The photography mode changeover plate 45 has a zone plate section 45a for the soft-focus photography. The zone plate section 45a will fit in the concave 42a when the photography mode changeover plate 45 rotates and hence moves between the position overlapped with a photographing optical path of the taking lens 5 and the position outside the photographing optical path.

A changeover ring 47 for changing over the shutter speed and photography mode is provided on an outer peripheral face of the lens attachment frame 43. The changeover ring 47 is connected to the mode changeover switch 15, and rotates interlocking therewith when the mode changeover switch 15 is slidably operated. The changeover ring 47 is pressed by the lens retention plate 44 not to be detached from the lens attaching frame 43. A spring 48 hooked on the changeover ring 47 provides biasing force to return the changeover ring 47 to the initial position when the mode changeover switch 15 is slid down.

The changeover ring 47 is provided with a pair of clamp pins 47a for clamping a first end portion 49a of a stop lever 49 that is attached to an upper portion of the shutter cover 40 and an interlocking pin 47b for moving the photography mode changeover plate 45. When the changeover ring 47 is rotated, the first end portion 49a moves in a horizontal direction to turn the stop lever 49 on the upper portion of the shutter cover 40. A second end portion 49b of the stop lever 49 is set underneath the syncro switch 31 in the normal photography mode, and retreats from underneath the syncro switch 31 in the soft-focus photography mode.

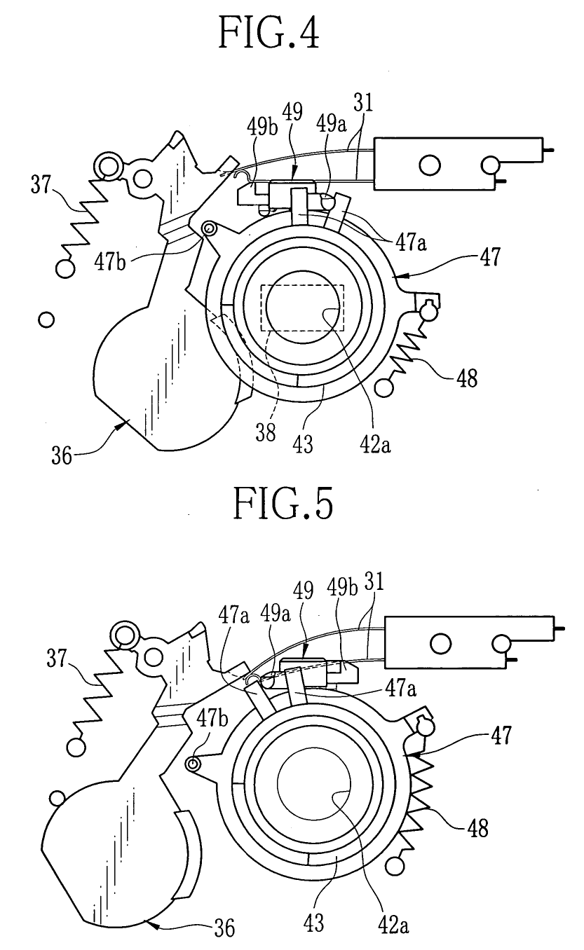

As shown in FIG. 4, the second end portion 49b of the stop lever 49 is set underneath the syncro switch 31 when the mode changeover switch 15 is not slid up. When the shutter blade 36 is actuated in this state, an upper end of the shutter blade 36 contacts a pair of metal contacts of the syncro switch 31. Since elastic deformation of the syncro switch 31 is stopped by a second end portion 49b of the stop lever 49, the opening movement of the shutter blade 36 is forcibly stopped.

When the mode changeover switch 15 is slid upward, the changeover ring 47 is turned in a counterclockwise direction as shown in FIG. 5. When the changeover ring 47 is turned in the counterclockwise direction, the clamp pins 47a move the first end portion 49a of the stop lever 49 in a left direction in FIG. 5. Then, the stop lever 49 turns to retreat the second end portion 49b of the stop lever 49 from underneath the syncro switch 31. When the shutter blade 36 is actuated in this state, the upper end portion of the shutter blade 36 contacts the couple of the metal contacts of the syncro switch 31 and the shutter blade 36 further turns.

When the movement of the shutter blade 36 is stopped by the stop lever 49, the turning angle of the shutter blade 36 is small and return of the shutter blade 36 starts earlier, so the fast shutter speed of, for example, 1/100 seconds is achieved. When the movement of the shutter blade 36 is not stopped by the stop lever 49, the turning angle of the shutter blade 36 is large and return of the shutter blade 36 starts late, so the slow shutter speed of, for example, 1/45 seconds is achieved. Accordingly, when the mode changeover switch 15 is slid down, exposure time is short and shutter speed is high, and when the mode changeover switch 15 is slid up, exposure time is long and shutter speed is low.

The flash emitter 7 emits flash light when the syncro switch 31 is turned on after the flash circuit completes charging. However, since the flash circuit is not charged when the flash switch 16 is set to OFF position, the flash emitter 7 does not emit flash light even when the syncro switch 31 is turned on.

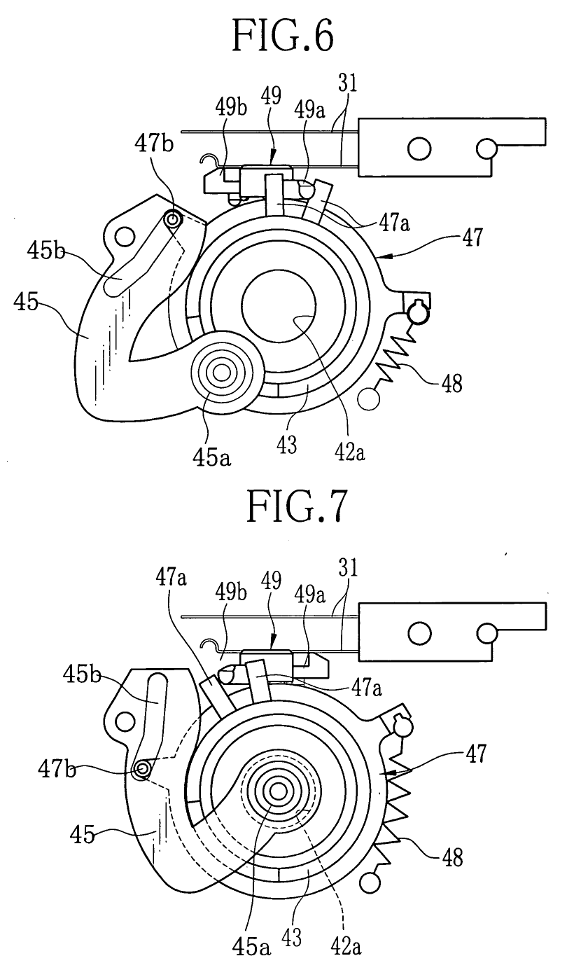

In FIGS. 6 and 7, the photography mode changeover plate 45 has a cam hole 45b that engages with the interlocking pin 47b of the changeover ring 47. When the interlocking pin 47b moves around the optical axis along with the rotation of the changeover ring 47, the photography mode changeover plate 45 turns. When the mode changeover switch 15 is slid up to select the soft-focus photography mode, the photography mode changeover plate 45 is turned to the position where the zone plate section 45a is overlapped with the opening 42a from the position where the zone plate section 45a retreats outside the photographing optical axis.

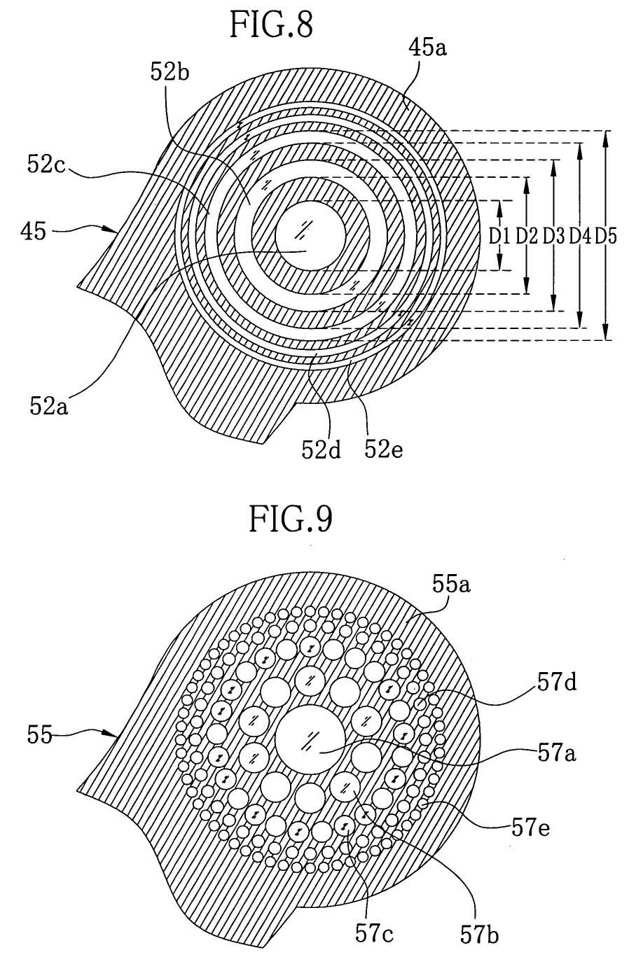

In FIG. 8, the photography mode changeover plate 45 is made of a colorless, transparent film whose thickness is, for example, 0.2 mm. The zone plate section 45a is defined into plural rings of transparent portions made of a transparent film and opaque portions made of a printing layer with high light blocking effect formed on the transparent film. Diameter “D” (mm) of each ring is obtained with coefficient “C”, wavelength of visible light “λ” (mm), focal distance of the zone plate “f” (mm) and number of the rings “N” by the following equation:
D×N=C×(f×N×λ)^{½}
It is noted that inner diameter of the opaque portion (shown with hatching) is obtained when “N” is odd number, and outer diameter of the opaque portion (shown with hatching) is obtained when N″ is even number. In this embodiment, the reference numeral 52a shows a central circular transparent part functioning as a pinhole. The reference numerals 52b to 52d show ring-shaped transparent parts to have function of increasing exposure amount.

In the zone plate to meet the equation mentioned above, each of the ring-shaped transparent parts 52b to 52d has the same area as the central circular transparent part. That is, the transparent portions and the opaque portions have same area, so ratio of light amount between the zone plate section 45a is located on the photographing optical path and when the zone plate section 45a is located outside the photographing optical path is 2:1. Reduced light amount due to the zone plate section 45a can be compensated by changing to the slow shutter speed to lengthen exposure time. The coefficient “C” is based on 2.0, and it is adjusted in the range of 1.6 to 2.2 for adjusting image quality in the photography using the zone plate only. Similarly, in the zone plate section 45a which is used with the taking lens 5, as a result of judging image quality by use of plural types of samples whose coefficient are in the range of 1.6 to 2.2, soft-focus effect is confirmed in all of the samples. Particularly, it is confirmed that the soft effect can be increased when the coefficient is decreased.

The operation of the lens-fitted photo film unit is explained now. When the photograph is taken, film winding operation is carried out until the film winding wheel 12 is locked. When the film winding wheel 12 is locked, the shutter charging is completed and photography is available. The camera operator selects either of the normal photography or soft photography.

For the soft photography mode, the mode changeover switch 15 is slid up. Interlocking with slide up of the mode changeover switch 15, the changeover ring 47 rotates. As shown in FIG. 5, the second end portion 49b of the stop lever 49 retreats from underneath the syncro switch 31, and the zone plate section 45a of the photography mode changeover plate 45 is inserted in the photographing optical path as shown in FIG. 7. When the shutter button 9 is depressed, the shutter blade 36 is actuated. Since the shutter blade 36 contacts the pair of the metal contacts of the syncro switch 31 and further presses them to deform before it returns, the shutter speed becomes slow.

Subject light falling on the taking lens 5 is transmitted through the front lens 5a and is diffracted when passing through the zone plate section 45a. And the subject light is transmitted through the rear lens 5b and reaches the photo film 23 through the shutter aperture 38. The subject light partially reaches the position off an ideal image point of the taking lens 5 due to the zone plate section 45a to form a photographing image having a soft effect that diffuses outline of the subject.

For the normal photography mode, the mode changeover switch 15 is slid down. In this case, the changeover ring 47 is set to the position shown in FIG. 4. The second end portion 49b of the stop lever 49 is positioned underneath the syncro switch 31. The zone plate section 45a is rotated by the interlocking pin 47b of the changeover ring 47, and is set to the position to retreat from the photographing optical path as shown in FIG. 6. Thus, the zone plate section 45a is not used in the normal photography mode.

When the shutter button 9 is operated, the shutter blade 36 starts rotating. As shown in FIG. 4, the shutter blade 36 contacts the sycnro switch 31 during rotation thereof and the rotation is stopped, so return of the shutter blade 36 starts earlier. Therefore, the photograph is taken at the fast shutter speed.

The present invention is not limited to the above embodiment, appropriate changes are acceptable. The above embodiment describes the present invention applied to the lens-fitted photo film unit, but the present invention is also applicable to a film interchangeable camera or an imaging device provided with a CCD image sensor.

The aforementioned embodiment describes the zone plate section 45a having the central circular transparent part and the ring-shaped transparent parts placed on the concentric circles, but alternatively a photography mode changeover plate 55 shown in FIG. 9 may be used. A zone plate section 55a may be formed with circular transparent parts (or openings) 57b to 57e in a concentric fashion around a central circular transparent part (or opening) 57a. Moreover, the photography mode changeover plate 45 is designed to move the zone plate between the position on the photographing optical path of the taking lens and the position off the photographing optical path by manual switching operation, but it may be possible to move the zone plate by using a driving source such as a solenoid.

Furthermore, in the above embodiment, the zone plate section 55a is disposed behind the taking lens 5 so that the zone plate section 55a functions as the stop of the taking lens 5, but when the zone plate section 55a is disposed in front of the taking lens 5, a typical stop may be separately disposed behind the taking lens 5. Different from the above embodiments, in a camera whose shutter speed is fixed, it is preferable to use a low-speed shutter for restraining reduction of exposure amount due to the zone plate, and it is also preferable to provide small and large stop plates in a movable fashion so that a small stop having a small aperture is used in a normal photography not using the zone plate and a large stop having a large aperture is used in a soft-focus photography using the zone plate.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A soft-focus photographing device, comprising:
a photographing lens disposed on a photographing optical path, for forming a subject light image on an image forming plane;
a shutter disposed in said photographing optical path, for controlling light amount of said subject light; and
a zone plate set on said photographing optical path, said zone plate having a central circular transparent part located on a center of said photographing optical path, and either of a plurality of ring-shaped transparent parts with different diameters formed around the central circular transparent part or a plurality of circular transparent parts respectively disposed on a plurality of concentric circles with different diameters.

2. A soft-focus photographing device according to claim 1, wherein each of said ring-shaped transparent parts or a total of said circular transparent parts disposed on each concentric circle has nearly the same area as said central circular transparent part.

3. A soft-focus photographing device according to claim 1, wherein said zone plate is insertable and removable from said photographing optical path,
further including a photography mode changeover mechanism for selecting either of a soft-focus photography mode or a normal photography mode, said zone plate being set on said photographing optical path in said soft-focus photography mode while retreating from said photographing optical path in said normal photography mode.

4. A soft-focus photographing device according to claim 3, wherein said shutter is set at slow speed in said soft-focus photography mode.

5. A soft-focus photographing device according to claim 3, wherein said zone plate has a thickness of at most 0.5 mm.

6. A soft-focus photographing device according to claim 3, wherein f-number of said photographing lens is greater than f/5.6, further including a photo film having ISO sensitivity of at least 800 disposed in said image forming plane.

7. A soft-focus photographing device according to claim 6, wherein said photographing lens has a first lens and a second lens, and wherein said zone plate is disposed between said first lens and said second lens.

8. A soft-focus photographing device according to claim 7, wherein said first lens is a meniscus lens.
